(19) United States
(12) Patent Application Publication
(10) Pub. No.: US 2008/0120646 A1
(43) Pub. Date: May 22, 2008

(54) Automatically associating relevant advertising with video content

(76) Inventors: Benjamin J. Stern, Morristownship, NJ (US); Mazin Gilbert, Warren, NJ (US); Narendra Gupta, Dayton, NJ (US)

Correspondence Address: AT&T CORP., ROOM 2A207, ONE AT&T WAY, BEDMINSTER, NJ, 07921, US

(21) Appl. No.: 11/601,993

(22) Filed: Nov. 20, 2006

(51) Int. Cl. H04N 7/10

(52) U.S. Cl. 725/34

(57) ABSTRACT

A method and system are provided for automatically selecting advertisements for placement in media content segments such as video segments. The method utilizes a classification engine to analyze values of a feature set extracted from the video segment, and to select one or more categories of advertisements to place in the segment. The classification engine is trainable using training data such as historical video segments in which advertisements were placed manually, and using performance data measuring the effectiveness of past advertisement placement in particular segments.

### FIELD OF THE INVENTION

The present invention relates generally to the placement of advertising messages in video programming. More particularly, the present application relates to a method and a system wherein a trainable classifier is used to select advertisement categories based on values of a feature set extracted from a video segment and its content.

### BACKGROUND OF THE INVENTION

Television advertisements are often carefully chosen for the programming with which they are run. For example, beer commercials are often shown with football games, and advertisements for financial institutions are shown with financial news programming. Network programmers manually choose which advertisements are to be placed in which shows. Advertisement placement decisions are therefore presently based on the experience and intuition of network and ad agency employees.

The volume of video and other programming content is growing rapidly as delivery channels for that content increase. Those channels include a vastly increased number of channels on digital television, video-on-demand cable and satellite services, and the proliferation of downloadable video content on the Web, such as video “podcasts” and video blogs. The availability of those channels has created a large increase in the available content itself.

That abundant and diverse content has the potential to generate significant revenue through advertising. The advertising can be made more valuable if the ads are chosen, based on the programming content, to be relevant to the likely audience. The greatly increased volume of video programming, however, precludes the placement of those advertisements by experienced advertising personnel.

Content directed to narrow audiences is now practical to produce because members of those audiences may now be selectively reached through Web channels and through specialized broadcast channels. That specialized content requires specialized advertisement placement to maximize revenue derived from such programming. The large volume of content directed to narrow audiences makes it difficult or impossible to individually place those advertisements.

U.S. Pat. No. 7,039,599 discloses a predictive model for use in placing advertisements such as Internet banner advertisements according to context such as date and time, and according to particular users' responses to past advertisements. That disclosure, however, provides no solutions for video programming.

There therefore remains a need for a cost-effective, automated technique for delivering relevant advertising with video media.

### SUMMARY OF THE INVENTION

The invention addresses the needs described above by providing a method and system for associating relevant advertisements with video media. In one embodiment of the invention, a method is provided for associating advertisements with a video segment. The method includes the steps of, for a training content set including a plurality of video segments in which a first set of advertisements has previously been placed, categorizing each of the first set of advertisements into advertisement categories based on characteristics of the advertisements; and extracting values of a feature set from each segment of the training content set. The method further includes the steps of training a classifier to associate the feature set values extracted from each segment of the training content set with advertisement categories in which advertisements placed in each segment were categorized; extracting new values of the feature set from a new video segment; using the trained classifier to select advertisement categories from the plurality of advertisement categories, based on the new values of the feature set; and placing advertisements categorized in the selected advertisement categories into the new video segment.

The advertisement characteristics may include a type of product sold, or an income of a target audience. The feature sets may include such features as a transcript of audio content, a length of a show, dates that content was created, reviews of the content, descriptions of the content, or viewer demographics. The training content set may include a broadcast programming block. The training content and the new content may both be video content. The training content and the new content may include metadata.

Another embodiment of the invention is a system for selecting categories of advertisements for placement in media content segments. The system includes a feature set extractor for extracting values of a feature set relating to a segment, the feature set characterizing the segment; and an advertisement category database containing a list of advertisement categories based on characteristics of the advertisements. The system further includes a classification engine in communication with the feature set extractor and the advertisement category database. The classification engine has a model for selecting at least one of the advertising categories based on extracted values of the feature set; and a training module for receiving training data relating historical values of the feature set to advertisement categories, and for updating the model based on the training data. The model may utilize any modeling technique; for example, the model may be a statistical model or a rule-based model.

The training data may include historical media content programming including video segments and advertisements placed in the segments. Those advertisements may be manually placed in the segments.

The training data may include performance data relating to advertisements placed in segments. The performance data may include sales data, or may include a quantity of network accesses responding to the advertisements.

The feature set extractor may extract information from video content of the segment, a transcript of audio material in the segment, or from metadata included in the segment.

### BRIEF DESCRIPTION OF THE DRAWINGS

FIG. 1 is a schematic representation of a system for delivering relevant advertising with video media according to one embodiment of the invention.

FIG. 2 is a schematic representation of a method for delivering relevant advertising with media content according to one embodiment of the invention.

### DESCRIPTION OF THE INVENTION

The present invention facilitates advertising for video “segments.” A “segment” as used herein is a part or whole presentation of video media. A segment may, for example, comprise a broadcast television “show” as that term is traditionally used in broadcast television. The term as used in this disclosure also encompasses portions of media that are otherwise coherent or can be grouped together. For example, individual scenes in a movie, or portions of a traditional television show between advertisement “spots,” may be considered segments under the presently used definition. Further, a “segment” may include video created by a user and uploaded, or a short video news clip.

Given the large amount of video content that is available through cable and satellite programming and on the Web, there is a need to quickly and cost-effectively associate advertisements with video segments based on the segment content. The present invention utilizes a trainable classifier to accomplish that task.

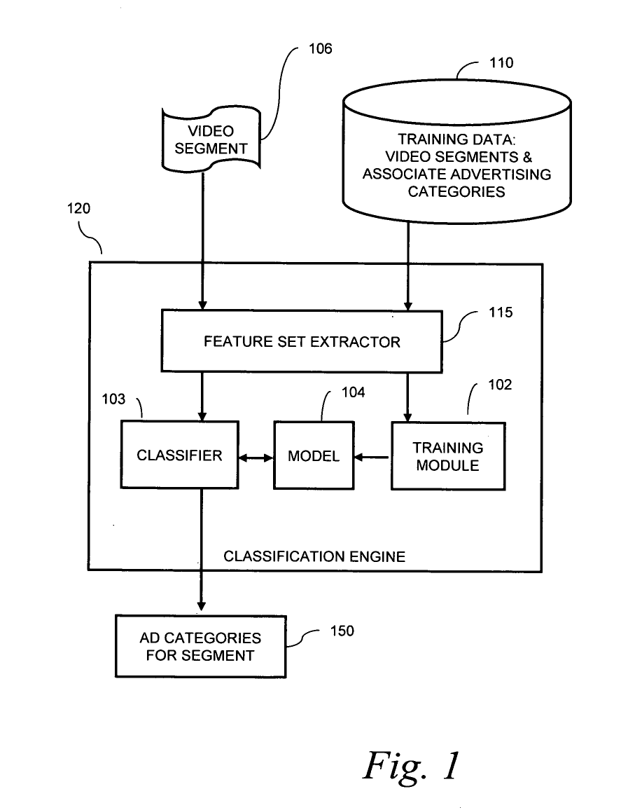

A schematic diagram of a system including a classification engine 120 according to one embodiment of the invention is shown in FIG. 1. A database 110 is a centralized or distributed database serving the engine 110. The database contains, among other data, a list of categories into which advertisements may be placed. The categories are selected to reflect various characteristics of the advertisements. The categories are further selected to be exhaustive; i.e., every advertisement is assignable to at least one advertisement category.

In one example, the categories are created to correspond to the products sold, such as food, household goods, services, transportation, etc. Various preexisting goods and services classification schemes may be used to establish an initial category system for the invention. Narrower categories yield more accurate advertisement selection criteria, but require larger memory space and greater processor speed. Because the system output 150 is one or more advertisement categories from which advertisements are selected to be placed in a video segment, narrower advertisement categories will more accurately identify advertisements to be placed in a given segment.

The advertisement categories may be based on criteria other than the marketed product type. For example, target market metrics such as age, ethnic background or income may be used to replace or supplement product type in creating the advertisement categories.

As described in more detail below, the database 110 may contain a lookup table in which known advertisements are tabulated with their appropriate categories. A single advertisement may be placed in a single category or in a plurality of categories.

A classification engine 120 includes a feature set extractor 115, a training module 102, a model 104 and a classifier 103. The feature set extractor 115 has an interface for receiving data representing a video segment 106 for which advertisements are to be selected. The segment 106 may be transmitted to the feature set extractor 115 as a static data file such as an MPEG file, or may be streamed to the feature set extractor. In addition to the information representing the segment itself, the segment 106 may contain metadata such as an audio or written text review, an audio or text plot summary, a show popularity ranking, viewer demographics, past advertising effectiveness for ads placed in the segment, or a movie rating.

The feature set extractor 115 extracts values for a set of characteristic features from the segment. The characteristic set of features for which values are extracted from the segment is predefined; i.e., the extractor 115 attempts to extract values of the same features from each segment. The set of features may, for example, be selected by a programmer, and may be chosen to represent those attributes of a video segment that would affect the optimum categories of advertisements to be placed in the segment. In one embodiment, the feature extractor may analyze the audio portion of the segment using a speech-to-text transcriber, and summarize the resulting transcript in terms of word counts (n-grams) or contextual phrases. The feature extractor may determine the length of the segment, the date the segment was created and contextual information such as the time and date that the segment is to be broadcast or transmitted, and characteristics of video segments occurring before and after the subject segment.

The feature extractor may also use graphics recognition to further determine characteristics of the segment such as subject matter, actor recognition, and the recognition of certain graphical images such as holiday symbols, etc. Typographical character recognition may be used to extract information from beginning and end credits included in the segment. The metadata transmitted with the video segment may also be collected by the feature extractor. For example, text in a plot summary may be used in word count totals.

Once values of a feature set of the segment 106 have been extracted by the feature set extractor 115, a classifier 103 containing a model 104 analyzes the values of the feature set and outputs a list of one or more advertisement categories 150, selected from the advertising categories of the database 110. Those categories 150 are used for selecting advertisements to place in the segment 106.

The classifier operates by weighting the various features in the feature set, according to a stored model. An initial, intuitive set of rules may be installed in the model 104 of the classification engine 120 as a start-up tool, to be later modified using training data, as described below.

The system of the invention allows generation of advertisement categories based on values of a feature set extracted from a short portion of a traditional television programming show. For example, a scene of a movie may deal with a tropical island; an advertising category relating to vacation travel may be the output 150 for that scene. The input “segment” 106 may advantageously be a shorter video clip than an entire movie or network television show.

According to a preferred embodiment of the invention, the classifier may be “trained”; i.e., it learns from historical or specially-created models and/or from successes and failures in previous runs. The classification engine 120 therefore incorporates a training module 102 for that purpose.

The training module 102 accepts feature set values extracted by the feature set extractor 115 from training data stored in the database 110 and utilizes that data to train the classifier. The training data 110 may be actual historical sample programming that contains video segments together with advertisements that are presumed to be placed correctly. For example, the training data may be taken from a period of actual programming (hours, days, weeks) on a set of cable channels. Preferably, the advertisements were placed in the video segments manually by experienced network personnel, and/or the advertisement placement has proven to be effective.

In that case, the training module 102 trains the classifier 103 by first analyzing the placement of ads in the sample programming. The analysis requires that the advertisement categories of the advertisements contained in the sample segment be determined. A particular advertisement may be placed into a category manually by an advertiser or an advertising agency, in which case the database 110 contains a lookup table tabulating all known advertisements and their corresponding classifications. Alternatively, the advertisements may be classified automatically based on extracted advertisement feature set values, in a manner similar to that described herein with respect to classifying video segments. In either case, the training module 102 obtains advertisement classifications for the advertisements in the training data from the database 110.

The training module 102 further obtains values of the feature set for each video segment in the training data of database 110, using the feature set extractor 115 in the classification engine 120. The training module 102 then trains the classifier 103 based on the feature set values and associated advertisement categories found in each video segment of the training data. In one embodiment, the training module retrieves an advertisement category output of the classifier using feature set values from the sample programming as an input. That output is compared with the actual advertisement categories used in the historical sample. The model in the classifier is then modified, taking into consideration that comparison.

Another type of training data is data indicating the relative success of advertising placed in media programming either manually or by an automatic system. The data may include sales numbers indicating the effectiveness of the advertising, or, in the case of Internet media, a number of “click-throughs” or network accesses. In either case, if the training data indicates that the advertising was successful, then a process similar to the one described above is implemented. If the data indicate that the advertising is unsuccessful, then the training module would train the classifier to avoid choosing advertisement categories resulting in advertisement placement similar to the unsuccessful placement in the training data, or to substitute an advertisement that is shown to be relatively more successful for similar values of the feature set.

In a special-case scenario, a measure of a fee offered by an advertiser to place the ad may be used in creating an advertising category. In that case, the classifier may be biased to place advertisements in that category in video segments having a high viewer rate or a high advertising effectiveness.

Once the classifier has been trained, it can be applied to new video segments and/or old segments viewed in new contexts. For each segment, the classifier will select one or more advertising categories. Assuming a large pool of candidate advertisements, a set of ads can be chosen from the classifier-selected categories for presenting with each video segment. For video segments that can be downloaded from Web sites or cable/satellite services “on demand,” the advertisements can be added at the beginning or end of a segment. For longer videos, scene detection algorithms can be used to insert advertisements within the segment. Those advertisements may be selected from advertisement categories chosen by the classifier 103 based on features of the individual scenes.

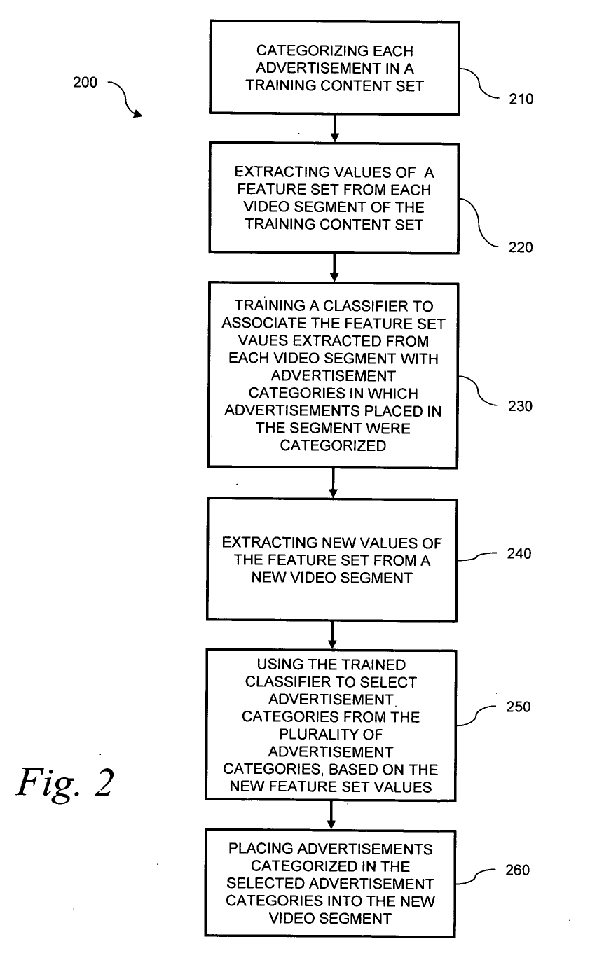

A method for associating advertisements with a media content segment in accordance with one embodiment of the invention is depicted in FIG. 2. The method first operates on training data that includes a plurality of segments in which a first set of advertisements has previously been placed. Preferably, the effectiveness of that advertisement placement is known. Each ad of the first set of advertisements is categorized (step 210) into advertisement categories based on characteristics of the advertisements. Values of a feature set are extracted (step 220) from each video segment of the training content set. The feature set comprises a plurality of features characterizing the video segments. A classifier is then trained (step 230) to associate values of the feature set extracted from each video segment with advertisement categories in which advertisements placed in the segment were categorized.

New values of the feature set are extracted (step 240) from a new video segment, the new values of the feature set comprising a plurality of values characterizing the new segment. Advertisement categories are then selected (step 250) from the plurality of advertisement categories using the trained classifier, based on the new values of the feature set. Advertisements categorized in the selected advertisement categories are then placed (step 260) into the new segment.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. For example, while the method of the invention is described herein with respect to inserting advertisements into video programming, the method and apparatus of the invention may be embodied by any system wherein one type of content is associated with another. For example, commentary, news announcements, sports scores and any other content may be selectively inserted into programming based on the methods of the invention. It is to be understood that the embodiments shown and described herein are only illustrative of the principles of the present invention and that various modifications may be implemented by those skilled in the art without departing from the scope and spirit of the invention.

What is claimed is:

1. A method for associating advertisements with a video segment, the method comprising the steps of:
for a training content set including a plurality of video segments in which a first set of advertisements has previously been placed:
categorizing each of the first set of advertisements into advertisement categories based on characteristics of the advertisements;
extracting values of a feature set from each segment of the training content set;
training a classifier to associate the feature set values extracted from each segment of the training content set with advertisement categories in which advertisements placed in each segment were categorized;
extracting new values of the feature set from a new video segment;
using the trained classifier to select advertisement categories from the plurality of advertisement categories, based on the new values of the feature set; and
placing advertisements categorized in the selected advertisement categories into the new video segment.

2. The method of claim 1, wherein the advertisement characteristics include a type of product sold.

3. The method of claim 1, wherein the advertisement characteristics include an income of a target audience.

4. The method of claim 1, wherein the feature set includes a transcript of audio content.

5. The method of claim 1, wherein the feature set includes a length of a show.

6. The method of claim 1, wherein the feature set includes dates that content was created.

7. The method of claim 1, wherein the feature set includes reviews of content.

8. The method of claim 1, wherein the feature set includes descriptions of the content.

9. The method of claim 1, wherein the feature set includes viewer demographics.

10. The method of claim 1, wherein the training content set comprises a broadcast programming block.

11. The method of claim 1, wherein the training content set is video content.

12. The method of claim 1, wherein the training content includes metadata.

13. A system for selecting categories of advertisements for placement in media content segments, comprising:
a feature set extractor for extracting values of a feature set relating to a segment, the feature set characterizing the media content segments;
an advertisement category database containing a list of advertisement categories based on characteristics of the advertisements;
a classification engine in communication with the feature set extractor and the advertisement category database, the classification engine including:
a classifier model for selecting at least one of the advertising categories based on extracted values of the feature set; and
a training module for receiving training data relating historical values of the feature set to advertisement categories, and for updating the classifier model based on the training data.

14. The system of claim 13, wherein the training data comprises historical media content programming including content segments and advertisements placed in the segments.

15. The system of claim 14, wherein the advertisements were manually placed in the segments.

16. The system of claim 13, wherein the training data comprises performance data relating to advertisements placed in segments.

17. The system of claim 16, wherein the performance data comprises sales data.

18. The system of claim 16, wherein the performance data comprises a quantity of network accesses responding to the advertisements.

19. The system of claim 13, wherein the feature set extractor extracts information from a transcript of audio material in the segment.

20. The system of claim 13, wherein the feature set extractor extracts information from metadata included in the segment.
